(19) United States
(12) Patent Application Publication
(10) Pub. No.: US 2007/0276720 A1
(43) Pub. Date: Nov. 29, 2007

(54) Indexing of a focused data set through a comparison technique method and apparatus

(75) Inventors: Charles Lu, Fremont, CA (US); Sadashiv Adiga, Hercules, CA (US)

Correspondence Address: RAJ ABHYANKER, LLP;c/o PORTFOLIOIP, P.O. BOX 52050, MINNEAPOLIS, MN, 55402, US

(73) Assignee: Campusl, Inc.

(21) Appl. No.: 11/441,590

(22) Filed: May 26, 2006

(51) Int. Cl. G06F 17/30

(52) U.S. Cl. 705/10

(57) ABSTRACT

A method and system to gauge effectiveness of deals in a shopping environment are disclosed. In one aspect, a method of a server device includes identifying a special offering data of a mark-up language site when identification data of the mark-up language site is matched with a deal marker data, comparing the special offering data with a parameter of a known offering data to determine a substantial match between the special offering data and the known offering data and periodically indexing the special offering data when the special offering data has a distinctive competitive advantage when compared with the known offering data. The deal marker data may be automatically populated through an algorithm that compares each offering on the mark-up language site with a market value of the each offering, such that the deal marker data is an identifier data associated with the special offering data having a selling price lower than a threshold value from the known offering data.

### FIELD OF TECHNOLOGY

This disclosure relates generally to the technical fields of software technology and, in one example embodiment, to an indexing of a focused data set through a comparison technique method and apparatus.

### BACKGROUND

A merchant (e.g., a seller, a lender, a service provider, etc.) may periodically advertise (e.g., through print, direct, online advertising, etc.) a portion of an inventory at a reduced selling price and/or with an attractive competitive position (e.g., longer warranty, faster shipping time, better availability, etc.). The merchant may have an excess stock of the portion of the inventory, may wish to discontinue carrying the portion of the inventory, and/or may have a sale of the portion of the inventory, etc. The merchant may create a section of a commerce website (e.g., a ‘deals’ section, a ‘clearance’ section, a ‘treasure chest’ section, a ‘basement’ section, an ‘attic’ section, a ‘specials’ section, etc.) specifically dedicated to advertising the portion of the inventory at the reduced selling price and/or with the attractive competitive position. The section of the commerce website may be periodically refreshed (e.g., monthly specials, holiday sales, etc.) when different items are made available at the reduced selling price and/or with the attractive competitive position.

A potential customer may respond to an advertisement of the merchant, and may consider purchasing (e.g., and/or leasing, renting, etc.) an item (e.g., a good, a service, etc.) in the portion of the inventory. The potential customer may need to spend time to manually research a market price of the item (e.g., checking prices on other websites of other merchants offering the item for sale) to appreciate whether the reduced selling price and/or the attractive competitive position presents a compelling transaction opportunity.

In addition, the potential buyer may periodically visit the section of the commerce website of the merchant (e.g., the potential buyer may enjoy ‘window shopping’ for bargains). As such, the potential buyer may enjoy browsing items that the merchant may periodically offer on the section of the commerce website, and/or similar sections of other merchants. However, the potential buyer may need to manually bookmark the section and similar sections of the other merchants. In addition, the potential buyer may need to remember to check frequently for new items placed in the section and/or the similar sections of the other merchants. This process can be time consuming for the potential buyer and cumbersome. In addition, the potential buyer may not be able to make a timely and/or informed decision about a latest set of items that may be of interest to the potential buyer.

### SUMMARY

An indexing of a focused data set through a comparison technique method and apparatus are disclosed. In one aspect, a method of a server device includes identifying a special offering data of a mark-up language site when an identification data of the mark-up language site is matched with a deal marker data, comparing the special offering data with a parameter of a known offering data to determine a substantial match between the special offering data and the known offering data and periodically indexing the special offering data when the special offering data has a distinctive competitive advantage when compared with the known offering data. The distinctive competitive advantage may be a larger available stock, a geographic proximity, a credibility rating, and/or a quality metric when compared to an industry benchmark. The industry benchmark may be periodically refreshed through an automatic comparison of the special offering data with the known offering data of a plurality of merchants. The parameter of the known offering data may be at least one of an item identifier, an item description, an item brand and/or an item price. The special offering data may be a portion of the mark-up language site, and only the portion of the mark-up language site having the special offering data may be periodically indexed.

The deal marker data may be automatically populated by evaluating a previously examined mark-up language site through an algorithm that compares each offering on the mark-up language site with a market value of the each offering, such that the deal marker data is an identifier data associated with the special offering data having a selling price lower than a threshold value from the known offering data. The threshold value may be less than 10% below the market value of the known offering data.

A deal index may be formed through periodical indexation of the special offering data. An item query of a client device may be analyzed using the deal index to determine a special item of the deal index that substantially matches the item query and a correlation of the special item with the item query may be evaluated to determine a ranking of the special item with other special items identified through the analyzing of the item query of the client device using the deal index. A clustered representation of the special item and the other special items may be generated through an algorithm that considers a grouping preference using a meta-data comparison with the item query and an absolute value of individual merchants offering the special item and the other special items.

A mark-up language file may be automatically populated through a client interaction module based on the correlation of the special item and the item query. A verified transaction data may be generated based on a selection of the special item and the verified transaction data may be communicated to a particular merchant offering the special item through a referral mark-up language page which automatically submits the verified transaction data to the particular merchant. Statistics may be generated based on the verified transaction data submitted to the particular merchant and a portion of funds collected through the verified transaction data may be allocated to the server device as a referral commission. A payment of an interested party may be processed when the mark-up language file develops a patron base above a threshold value and a subscription service may be offered on the mark-up language file associated with the interested party when the patron base is above the threshold value. The subscription service may be an advertisement space, a sponsored recommendation and/or a web feature.

In another aspect, a method of a merchant device may include segregating a portion of an inventory data as a special offering data, placing the special offering data in a separate mark-up language document and permitting an indexing of the separate mark-up language document when the special offering data has a distinctive competitive advantage over a standard market offering data identifying a substantially similar offering. A verified transaction data may be processed through a server device when a user of a deal index of the server device discovers the special offering data through an item query of the deal index.

In yet another aspect, a system includes a plurality of merchant devices to segment a special inventory data from other inventory data and a server device communicatively coupled to the plurality of merchant devices to index the special inventory data when a portion of the special inventory data has a market value that is less than a threshold percentage as compared to an offer price of the portion of the special inventory data. The server device may automatically discover segment of the special inventory data by examining a link identifier associated with a mark-up language document of each of the plurality of merchant devices against a deal identifier library of the server device.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of a server device communicating with a merchant device having a deal section and a client device through a network, according to one embodiment.

FIG. 2 is a block diagram of the server device of FIG. 1, having a deal analysis module, a deal processing module, a query analysis module, a transaction module a deal index, an inventory database and a deal marker database, according to one embodiment.

FIG. 3 is a user interface view of the merchant interaction module of FIG. 2, according to one embodiment.

FIG. 4 is a user interface view of the mark-up language file of FIG. 2, according to one embodiment.

FIG. 5 is a table view of the deal index of FIG. 2, according to one embodiment.

FIG. 6 is a diagrammatic representation of a data processing system capable of processing a set of instructions to perform any one or more of the methodologies herein, according to one embodiment.

FIG. 7 is an interaction diagram of a process flow between the server device, the merchant device and the client device, according to one embodiment.

FIG. 8 is a flow chart illustrating a method of the server device of FIG. 1 to identify and evaluate effectiveness of a special offering data, according to one embodiment.

FIG. 9 is a process diagram that describes further the operations in FIG. 8, according to one embodiment.

FIG. 10 is a process diagram that describes further the operations in FIG. 9, according to one embodiment.

FIG. 11 is a flow chart illustrating a method of the merchant device of FIG. 1 to segregate and permit indexing of the special offering data.

Other features of the present embodiments will be apparent from the accompanying drawings and from the detailed description that follows.

### DETAILED DESCRIPTION

An indexing of a focused data set through a comparison technique method and apparatus. In the following description, for the purposes of explanation, numerous specific details are set forth in order to provide a thorough understanding of the various embodiments. It will be evident, however to the one skilled in the art that the various embodiments may be practiced without these specific details.

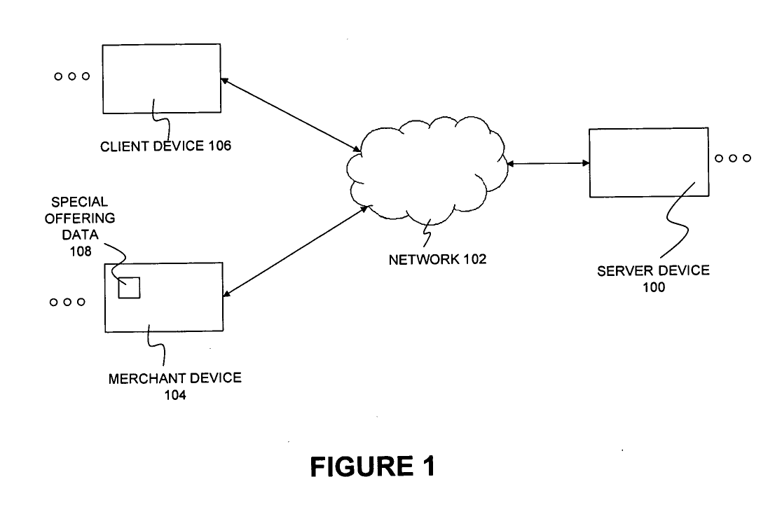

An example embodiment provides method and systems of a server device 100 (e.g., as illustrated in FIG. 1) to identify a special offering data (e.g., the special offering data 108 of FIG. 1) of a mark-up language site (e.g., a merchant web-site) when an identification data of the mark-up language site is matched with a deal marker data (e.g., keywords, identification data, etc.), compare the special offering data (e.g., deal data associated to an item) with a parameter (e.g., product identifier, product description, product brand, etc.) of a known offering data (e.g., stored inventory data) to determine a substantial match between the special offering data and the known offering data and periodically index the special offering data when the special offering data has a distinctive competitive advantage (e.g., in terms of item price, item availability, item quality etc.) when compared with the known offering data.

Another example embodiment provides methods and systems of a merchant device 104 (as illustrated in FIG. 1) to segregate (e.g., classify and/or separate) a portion of an inventory data as a special offering data 108, place the special offering data in a separate mark-up language document (e.g., a web page) and permit an indexing of the separate mark-up language document (e.g., by the server device 100 of FIG. 1) when the special offering data has a distinctive competitive advantage over a standard market offering data (e.g., standard market value of an item) identifying a substantially similar offering.

An additional example embodiment provides methods and systems of a plurality of merchant devices (e.g., the merchant device 104 of FIG. 1) to segment a special inventory data from other inventory data and a server device 100 (e.g., as illustrated in FIG. 1) communicatively coupled to the plurality of merchant devices to index the special inventory data (e.g., data associated to items that have special deals) when a portion of the special inventory data has a market value (e.g., selling price) that is less than a threshold percentage as compared to an offer price (e.g., market price) of the portion of the special inventory data. It will be appreciated that the various embodiments discussed herein may/may not be the same embodiment, and may be grouped into various other embodiments not explicitly disclosed herein.

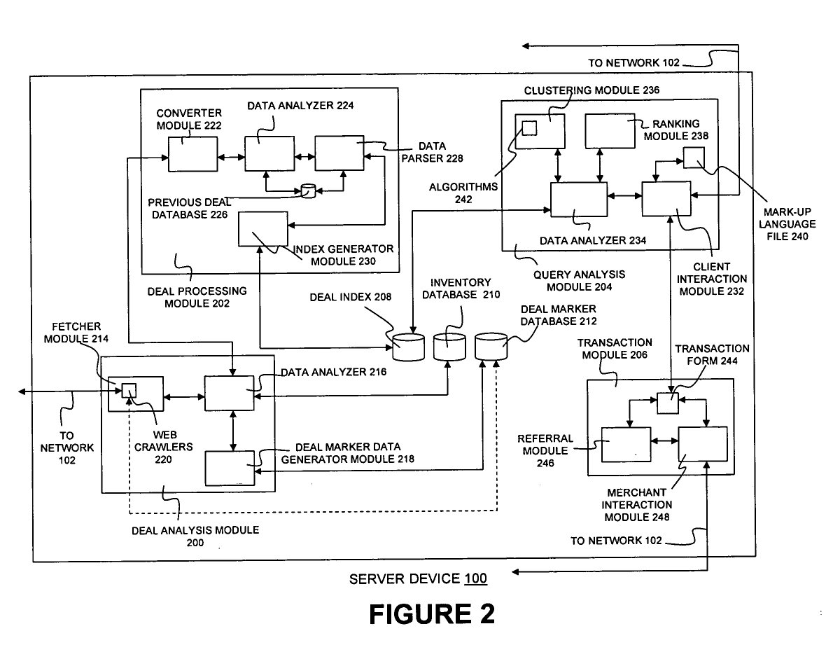

FIG. 1 is a network diagram of a server device 100, a merchant device 104 and a client device 106 communicating a special offering data 108 through a network 102 (e.g., an internet network, a wide area network, a local area network, etc.), according to one embodiment. In one embodiment, the merchant device 104 segments a special inventory data (e.g., inventory data that have specials and/or deals associated to them) from other inventory data (e.g., regular inventory data without special pricing and/or deals). The merchant device 104 may place the special offering data 108 (e.g., the special inventory data) in a separate mark-up language document (e.g., a separate webpage dedicated to special offerings and/or deals). The server device 100 may communicate with a plurality of merchant devices (e.g., the merchant device 104) to index (e.g., list) the special inventory data (e.g., the special offering data 108) when a portion of the special inventory data has a market value (e.g., selling price) that is less than a threshold percentage (e.g., a set minimum) as compared to an offer price (e.g., market price) of the portion of the special inventory data, according to one embodiment. The server device 100 is best understood with reference to FIG. 2, as will later be described.

FIG. 2 is a block diagram of the server device 100 (e.g., the server device 100 of FIG. 1), having a deal analysis module 200, a deal processing module 202, a query analysis module 204, a transaction module 206 a deal index 208, an inventory database 210 and/or a deal marker database 212, according to one embodiment. The deal analysis module 200 may include a fetcher module 214, a data analyzer 216 and/or a deal marker data generator module 218. In one embodiment the server device 100 identifies a special offering data 108 (e.g., the special offering data 108 of FIG. 1) of a mark-up language site (e.g., a mark-up language site associated to the merchant device 104) when an identification data of the mark-up language site is matched with a deal marker data (e.g., keywords, deal identification data, etc.).

The fetcher module 214 may fetch the special offering data 108 from the merchant device 104. Particularly the web crawlers 220 of the fetcher module 214 may send out crawlers to search mark-up language site(s) associated to the merchant device 104. The web crawlers 220 may reference the deal marker database 212 to identify the special offering data 108 by comparing (e.g., looking for a corresponding match) attributes of the deal marker data (e.g., keywords, deal identification data, etc.) to identification data (e.g., description, headings, etc) of the mark-up language site having the special offering data 108.

The deal marker data generator module 218 may generate deal marker data required to identify the special offering data 108 (e.g., when keywords associated to the deal marker data fail to identify a single special offering data on a merchant web-page). In one embodiment, the deal marker data may be automatically populated (e.g., generated, added and/or updated) by evaluating a previously examined mark-up language site (e.g., a mark-up language file that was previously examined by the fetcher module 214 and did not return any matches for the deal marker data) through an algorithm that compares each offering (e.g., data associated to each item) on the mark-up language site with a market value (e.g., market price) of the each offering (e.g., by referencing the inventory database 210), such that the deal marker data is an identifier data (e.g., the identification data) associated with the special offering data 108 having a selling price lower than a threshold value from the known offering data (e.g., known inventory data).

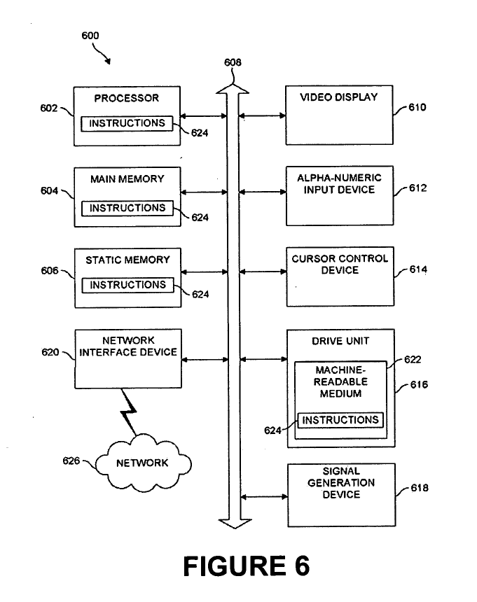

The threshold value may be less than 10% below the market value of the known offering data (e.g., 10% cheaper than the existing market price). For example, the fetcher module 214 may identify several items on a web page (e.g., with the help of the data analyzer 216 and the inventory database 210) that may be good deals (e.g., equivalent to a special offering data 108) but which are not categorized by the merchant as a special offering data 108. The data analyzer 216 may receive and/or process (e.g., by using the processor 602 of FIG. 6) the special offering data 108 once identified by the fetcher module 214.

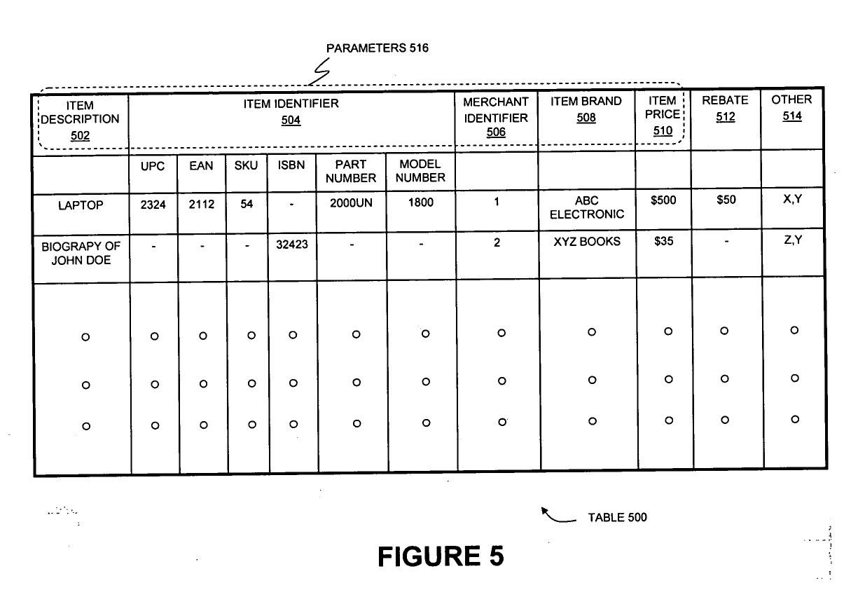

The server device 100 compares the special offering data 108 with a parameter (e.g., attributes) of a known offering data (e.g., known inventory data) to determine a substantial match between the special offering data and the known offering data, according to one embodiment. Particularly the substantial match may be determined by the data analyzer 216 by referencing the inventory database 210 and comparing the special offering data 108 to the parameter(s) (e.g., the parameters 516 of FIG. 5) associated to the inventory data (e.g., inventory items in the inventory database 210).

In one embodiment, the server device periodically indexes the special offering data 108 when the special offering data 108 has a distinctive competitive advantage (e.g., in terms of item price, item availability, item quality etc.) when compared with the known offering data. The data analyzer 216 may further analyze the special offering data 108 (e.g., by comparing values associated to the parameters 516 of the special offering data 108 with parameter values associated to the known offering data that match the special offering data 108) to determine and/or identify the distinct competitive advantage.

The distinctive competitive advantage may be a larger available stock, a geographic proximity (e.g., closer to the buyer that may translate to a shorter shipping period), a credibility rating (e.g., merchant credibility, user rating of merchant, etc.), and/or a quality metric (e.g., product quality) when compared to an industry benchmark (e.g., a known industry standard). The industry benchmark may be periodically refreshed (e.g., by refreshing items of the inventory database 210) through an automatic comparison of the special offering data 108 with the known offering data (e.g., associated to known inventory items) of a plurality of merchants (e.g., like the merchant device 104 of FIG. 1). The data analyzer 216 may then communicate the special offering data 108 to the deal processing module 202 for indexation.

The deal processing module 202 may include a converter module 222, a data analyzer 224, a previous deal database 226, a data parser 228 and/or an index generator module 230, according to one embodiment. The converter module 222 may convert the special offering data 108 (e.g., the special offering data 108 communicated by the data analyzer 216) to a structured format (e.g., an organized format and/or a process conducive format) prior to processing of the special offering data 108 having a set of parameters 516 (e.g., the parameters 516 of FIG. 5), according to one embodiment.

The deal processing module may process (e.g., by using a processor 602 of FIG. 6) the special offering data 108 (e.g., the special offering data 108 of FIG. 1) to determine a set of parameters (e.g., the parameters 516 illustrated in FIG. 5) associated with the special offering data 108. Particularly the set of parameters may be determined by the data analyzer 224 by referencing the previous deal database 226 and carrying out a comparative analysis of the special offering data 108 (e.g., comparison of attributes and/or parameters associated to the special offering data 108 by a merchant to attributes associated to a previous special offering data of the same merchant) to identify a portion of the set of parameters which do not need to be updated (e.g., parameters that are common and/or similar in both the special offering data 108 and the previous special offering data of the previous deal database 226). The set of parameters (e.g., the parameters 516 of FIG. 5) determined by the data analyzer 224 may then be parsed (e.g., extracted) from the special offering data 108 using the data parser 228.

The index generator module 230 may generate a deal index 208 based on a feed (e.g., processed data) supplied by the data parser 228. In one embodiment, a deal index 208 may be formed through periodical indexation of the special offering data 108. Particularly the index generator module 230 may create the deal index 208 by using an incremental algorithm to infuse (e.g., introduce) the set of parameters (e.g., the set of parameters determined by the data analyzer 224) into a preexisting index (e.g., an index having substantially similar data as the deal index 208). Moreover, the special offering data 108 may be a portion of the mark-up language site (e.g., the mark-up language site of the merchant device 104), and only the portion of the mark-up language site having the special offering data 108 may be periodically indexed (e.g., by using the deal marker data).

The query analysis module 204 may include a client interaction module 232, a data analyzer 234, a clustering module 236, a ranking module 238 and/or a mark-up language file 240, according to one embodiment. The client interaction module 232 may serve as an interface between the client device 106 (e.g., the client deice 106 in FIG. 1) and the merchant device 104 (e.g., the merchant device 104 of FIG. 1). A user (e.g., a potential buyer) of the client device 106 may post an item query 410 (e.g., search for an item) to the server device 100 through the client interaction module 232.

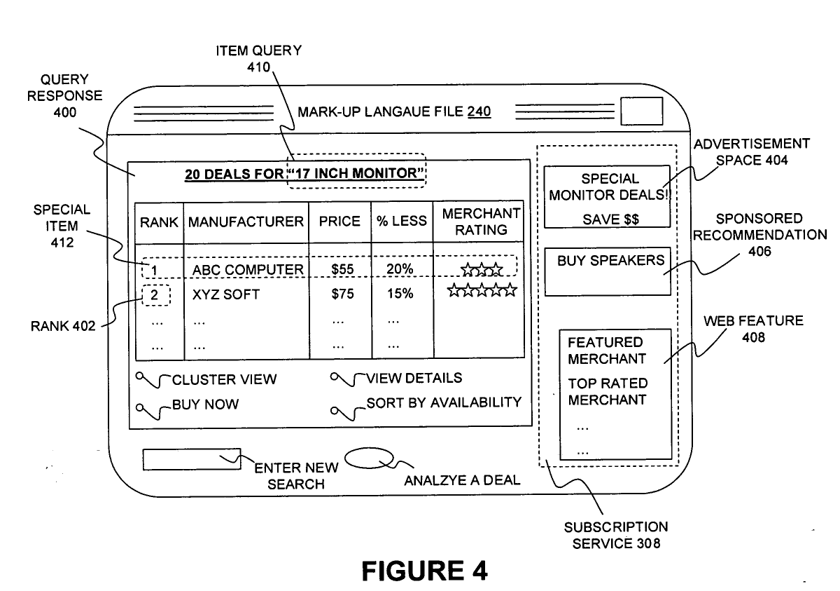

In one embodiment, the item query 410 (e.g., the item query 410 of FIG. 4) of the client device 106 may be analyzed using the deal index 208 to determine a special item 412 (e.g., the special item 412 of FIG. 4) of the deal index 208 that substantially matches the item query 410. Particularly the item query 410 is received by the data analyzer 234 and analyzed and/or processed (e.g., by using the processor 602 of FIG. 6) by comparing the item query 410 to the deal index 208 (e.g., comparison of specific keywords in the item query 410 to the content associated to the deal index 208) to determine a special item of the deal index 208 (e.g., extract and/or determine a item through a item identifier, item description, item brand, etc. associated to item(s) in the deal index 208) that match (e.g., correspond) to the item query 410.

The ranking module 238 may be used to rank the special item (e.g., the special item 412 of FIG. 4) determined by the data analyzer 234. In one embodiment, a correlation (e.g., a relationship) of the special item with the item query 410 may be evaluated (e.g., based on price, condition, quality, best match, etc.) to determine a ranking (e.g., a rank 402 of FIG. 4) of the special item with other special items (e.g., other items of the deal index 208 that also match the item query 410) identified through the analyzing of the item query 410 (e.g., by the data analyzer 234) of the client device 106 using the deal index 208.

The clustering module 236 may include an algorithms 242, according to one embodiment. The clustering module 236 may generate a clustered representation (e.g., representation of items in the form of item clusters and/or item group formed by logical grouping of the items) of the special item (e.g., the special item 412 of FIG. 4) and the other special items through algorithms 242. Specifically the data analyzer 234 may reference the algorithms 242 (e.g., grouping and/or clustering algorithms) of the clustering module 236 and consider a grouping preference based on a meta-data comparison with the item query 410 (e.g., comparison of attributes of the special item and other special items with the attributes of the item query 410) and an absolute value of individual merchants (e.g., count of unique merchants) offering the special item and the other special items, according to one embodiment. For example, an item being offered by ‘5’ unique merchants may be ranked before a similar item being offered by ‘2’ unique merchants.

The client interaction module 232 may reference the data analyzer 234 and automatically populate a mark-up language file 240 with the clustered representation and/or the ranking correlation of the special item and the other special item in response to the item query (e.g., the item query 410 of FIG. 4). The contents of the mark-up language file 240 may be best understood with reference to FIG. 4, as will later be described.

The transaction module 206 may include a transaction form 244, a referral module 246 and/or a merchant interaction module 248, according to one embodiment. In one embodiment, the transaction module 206 may generate a verified transaction data (e.g., item information, shipping information, price information etc associated to a particular item) based on a selection of the special item (e.g., based on user selection). The transaction form 244 may be used to facilitate transaction(s) (e.g., by permitting a user to enter transaction data in the transaction form 244 which may serve as a template) between a user (e.g., a buyer) and the merchant device 104 (e.g., the merchant device 104 of FIG. 1) through the server device 100 (e.g., the server device 100 of FIG. 1).

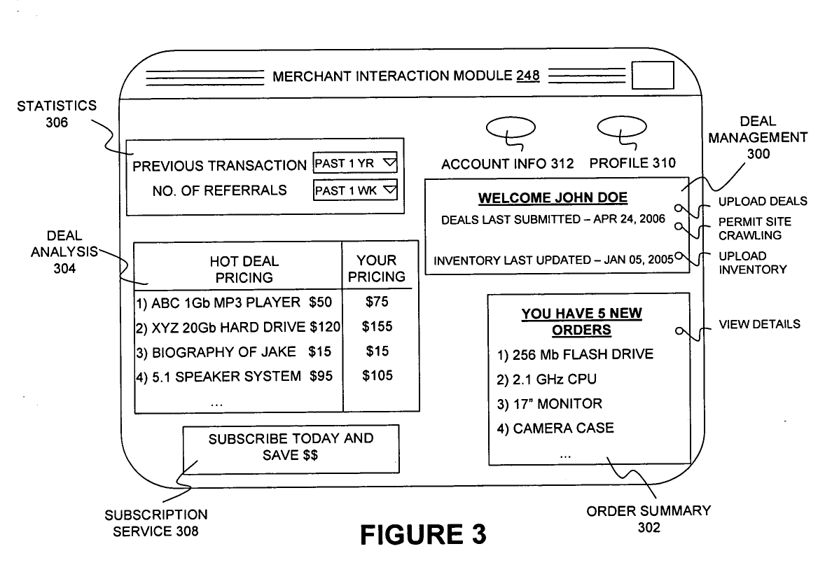

The verified transaction data may be communicated (e.g., through the merchant interaction module 248) to a particular merchant (e.g., the merchant device 104 of FIG. 1) through a referral mark-up language page (e.g., by using the referral module 246) which automatically submits the verified transaction data to the particular merchant. In one embodiment the transaction module 206 may generate a statistics 306 (e.g., referral statistics as illustrated in FIG. 3) based on the verified transaction data (e.g., by using the referral module 246 to analyze the verified transaction data and generate a hierarchy of the transactions associated to a merchant) submitted to the particular merchant (e.g., merchant chosen based on user selection of the special item) and allocate a portion of funds (e.g., funds paid by user for the requested item) collected through the verified transaction data to the server device 100 as a referral commission (e.g., a commission for transaction services rendered to the merchant device 104).

The transaction module 206 may process a payment of an interested party (e.g., a merchant, a service vendor, etc.) when the mark-up language file 240 develops a patron base (e.g., a user base) above a threshold value (e.g., a set minimum) and may offer a subscription service 308 (e.g., the subscription service 308 of FIG. 4) on the mark-up language file 240 associated with the interested party (e.g., an advertisement of the interested party) when the patron base is above the threshold value, according to one embodiment. The merchant interaction module 248 may serve as an interface between the merchant device 104 and the client device 106 to process, manage client-merchant and/or server-merchant interactions (e.g., communicate transaction data, manage merchant relationships, etc.). Other aspect of the merchant interaction module 248 may be best understood with reference to FIG. 3, as will later be described.

FIG. 3 is a user interface view of the merchant interaction module 248 of FIG. 2, according to one embodiment. The user interface view may include a deal management view 300, an order summary view 302, a deal analysis view 304, statistics 306, a subscription service 308, a profile view 310 and/or an account information view 312. The deal management view 300 may provide a summary (e.g., a time stamp of deals last updated and/or submitted, number of deals indexed, current inventory size, etc.) related to the special offering data (e.g., the special offering data 108 of FIG. 1) identified by the server device 100.

The deal management view 300 may also allow the merchant device 104 to set and/or change site crawling permissions (e.g., permission to search merchant site for special offering data 108). The order summary view 302 may provide a summary (e.g., a list and/or detailed information) of orders (e.g., special items purchased by user(s)) generated from the verified transaction data based on selection of particular special item(s) by the user(s) (e.g., a buyer). The deal analysis view 304 may provide an analysis of the special offering data 108 identified on the mark-up language site (e.g., the mark-up language site associated to the merchant device 104). For example, the analysis may provide a list of special offering items (e.g., hot deals, special deals, etc. illustrated by ‘ABC 1 Gb mp3 player’ ‘$50’ in the Figure) and compare the list to the special offering data 108 (e.g., ‘$75’ for the ‘ABC 1 Gb mp3 player’ as illustrated in the Figure) of the merchant device 104 to check and/or compare deals offered by the merchant device 104 with the list of special offering items (e.g., hot deals, special deals, etc.).

The statistics 306 may provides a statistical analysis (e.g., number of user referrals, preference of users, etc.) of users referred to the merchant device 104 through the server device 100. The statistical analysis may be generated though the verified transaction data (e.g., as described in FIG. 2). The subscription service 308 may allow a merchant to sign-up and/or subscribe to a subscription service 308 (e.g., a paid service as illustrated in FIG. 4) offered by the server device 100. The subscription service 308 may be an advertisement space 404 (e.g., the advertisement space 404 of FIG. 4), a sponsored recommendation 406 (e.g., the sponsored recommendation 406 of FIG. 4) and/or a web feature 408 (e.g., the web feature 408 of FIG. 4). The account information view 312 may display subscription information about the merchant (e.g., balance, account preference, etc.). The profile view 310 may include data about the merchant (e.g., name, address, email address and/or transaction preference, etc.).

FIG. 4 is a user interface view of the mark-up language file 240 of FIG. 2, according to one embodiment. The user interface view may include a query response 400, a rank 402, an advertisement space 404, a sponsored recommendation 406, a web feature 408, an item query 410 and/or a special item 412. The query response 400 provides a summary (e.g., a result summary) of the query response 400 generated by the data analyzer 234 (e.g., as described in FIG. 2) in response to the item query (e.g., the item query 410) posted by a user. The special item 412 may be the special item that substantially matches the item query (e.g., the item query 410) determined based on the analysis of an item query (e.g., by the data analyzer 234 as illustrated in FIG. 2) of a client device (e.g., the client device 106 of FIG. 1) using the deal index (e.g., the deal index 208 of FIG. 2). For example, the special item 412 shows a ‘17 inch monitor’ manufactured by ‘ABC Computer’ with a price of ‘$55’, which is ‘20%’ lower than the known offering rate (e.g., based on the inventory database 210 determined by the data analyzer 216 of FIG. 1) offered by a merchant having a rating of ‘3 stars’.

The rank 402 shows the rank for a special item. The rank 402 shows the ranking for a special item (e.g., the special item 412) as determined by an evaluation of correlation between the special item and the item query with respect to other special items (e.g., as described by the ranking module 238 of FIG. 2). For example, as illustrated in the Figure, the special item ‘17 inch monitor’ manufactured by ‘ABC Computer’ has a price of ‘$55’ which is ‘20%’ less than offering price (e.g., of an equivalent item in the inventory database 210 of FIG. 1) compared to the ‘17 inch monitor’ manufactured by ‘XYZ soft’ which has a value of ‘15%’ less than the offering price. Hence the special item ‘17 inch monitor’ manufactured by ‘ABC Computer’ is ranked before the special item ‘17 inch monitor’ manufactured by ‘XYZ Online’.

The advertisement space 404 may be a place for displaying advertisements of an interested party (e.g., a merchant) who may have subscribed for subscription service 308 (e.g., the subscription service 308 of FIG. 3). The sponsored recommendation 406 may be an area on the mark-up language file 240 (e.g., the mark-up language file 240 of FIG. 2) for displaying recommendations (e.g., specific recommendations based on user query) of an interested party (e.g., a merchant) who may have signed-up for subscription service 308. The web feature 408 may be a section on the mark-up language file 240 to promote an interested party (e.g., through merchant ratings, special merchant features, etc.) who may have opted for the subscription service 308.

FIG. 5 is a table view of content of the deal index 208 of FIG. 1, according to one embodiment. The table 500 in FIG. 5 may include an item description field 502, an item identifier field 504, a merchant identifier field 506, an item brand field 508, an item price field 510, a rebate field 512 and/or an other field 514. Parameters 516 associated with the special offering data 108 (e.g., the special offering data 108 of FIG. 1) may be an item identifier (e.g., a SKU number, a UPC number, a model number, a part number etc.), an item description (e.g., item name, specification, etc.), a merchant identifier (e.g., an identity tag associated to a merchant) and/or an item brand (e.g., item make, manufacturer, etc.).

The item description field 502 may be a name and/or a description tag associated with a special item (e.g., the special item 412 of FIG. 4). The item identifier field 504 may be reference identifier (e.g., information to identify and/or distinguish an item) associated with the special item. The merchant identifier field 506 may be a reference tag associated to a particular merchant to keep a track of special items offered by the particular merchant. The item brand field 508 may be a brand name and/or a brand description tag associated with the special item. The item price field 510 may be a price associated with the special item. The rebate field 512 may be a refund and/or discount associated to the special item. The other field 514 may indicate miscellaneous and/or additional information relevant to the special item.

For example, two special items are illustrated in FIG. 5 (e.g., ‘Laptop’ and ‘Biography of John Doe’). The special item ‘Laptop’ has a UPC value ‘2324’, EAN value ‘2112’, SKU value ‘54’, part number value ‘2000UN’, model number ‘1800’ in the item identifier field 504 indicating reference identifier(s) (e.g., a universal product code, a european article number, a store keeping unit, item part number, item model number etc. ) associated with ‘Laptop’. The merchant identifier field 506 has a value ‘1’ indicating the merchant reference number associated with the special item ‘Laptop’. The item brand field 508 has a value ‘ABC Electronic’ indicating the brand name associated with the special item ‘Laptop’. The item price field 510 has a value of ‘$500’ indicating the price of the special item. The rebate field 512 has a value of ‘$50’ indicating a refund and/or a discount on the special item ‘Laptop’. In addition special item ‘Laptop’ includes ‘X, Y’ in the other field 514, indicating any supplemental information that may be relevant to the item ‘Laptop’.

Item ‘Biography of John Doe’ has an ISBN value ‘32423’ in the item identifier field 504 indicating the reference identifier (e.g., international standard book number) associated with ‘Biography of John Doe’. The merchant identifier field 506 has a value ‘2’ indicating the merchant reference number associated with the item ‘Biography of John Doe’. The item brand field 508 has a value ‘XYZ Books’ indicating the publisher name associated with the item ‘Biography of John Doe’. The item price field 510 has a value ‘$35’ indicating the price associated with the item ‘Biography of John Doe’. In addition item ‘Biography of John Doe’ includes ‘Z, Y’ in the other field 514, indicating any supplemental information that may be relevant to the item ‘Biography of John Doe’.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media.

The software 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

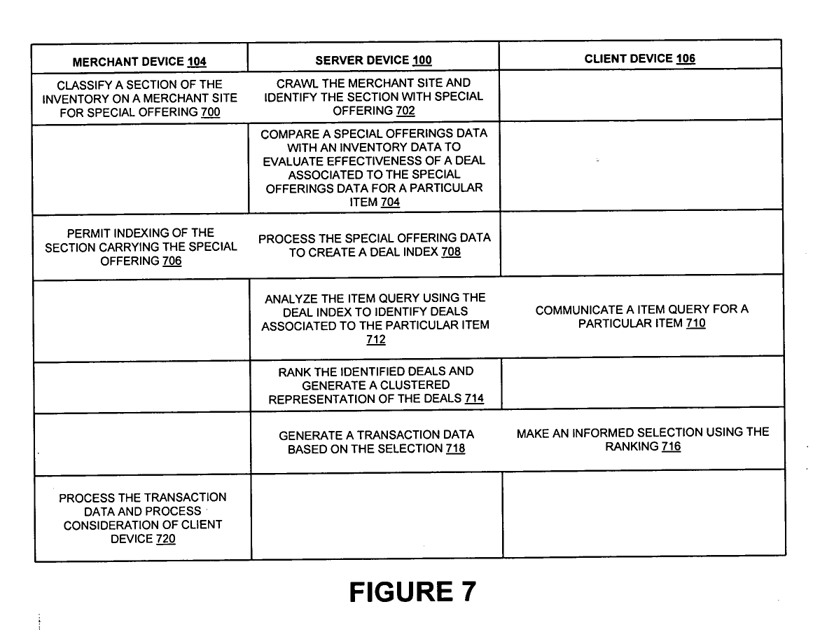

FIG. 7 is an interaction diagram of a process flow between the merchant device 104, the server device 100 and the client device 106 of FIG. 1, according to one embodiment. In operation 700, the merchant device may classify a section of the inventory on a merchant site for special offering. In operation 702, the server device may crawl the merchant site and identify the section with special offering. In operation 704, the server device may compare a special offerings data with an inventory data to evaluate effectiveness of a deal associated to the special offerings data for a particular item. In operation 706, the merchant device may permit indexing of the section carrying the special offerings.

In operation 708, the server device may process the special offering data to create a deal index. In operation 710, the client device may communicate a item query for a particular item. In operation 712, the server device may analyze the item query using the deal index to identify deals associated to the particular item. In operation 714, the server device may rank the identified deals and generate a clustered representation of the deals. In operation 716, the client device may make an informed selection using the ranking. In operation 718, a transaction data based may be generated by the server device based on the selection. In operation 720, the merchant device may process the transaction data and process consideration of the client device.

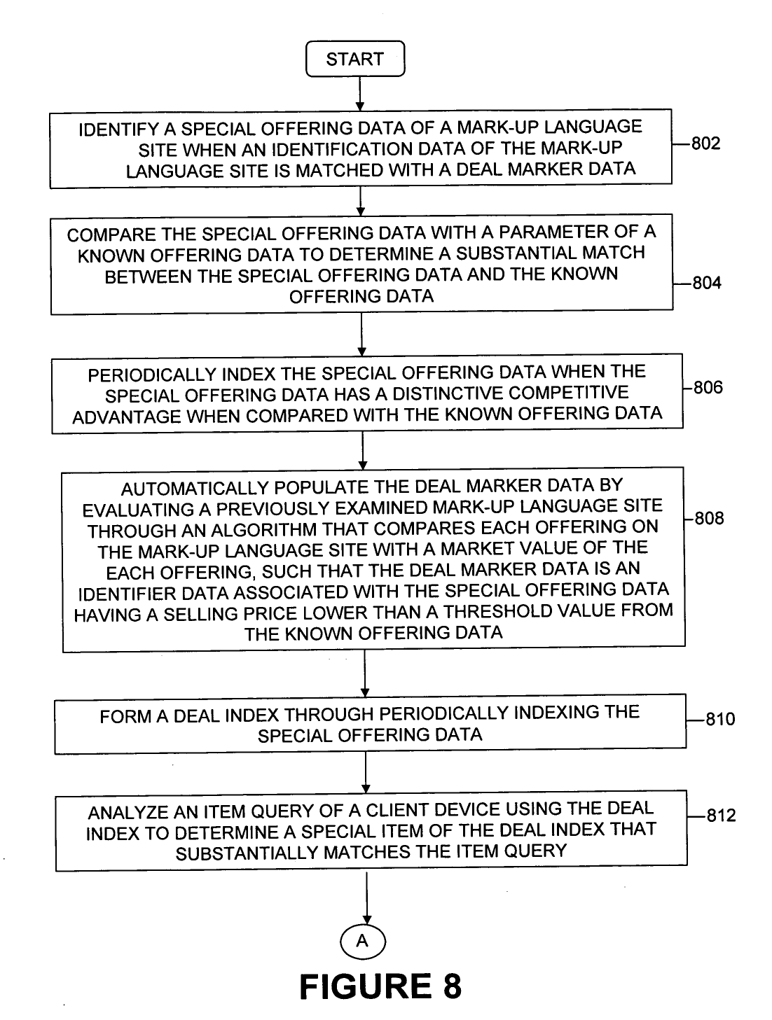

FIG. 8 is a flow chart illustrating a method of the server device 100 (e.g., the server device 100 of FIG. 1) to identify and evaluate effectiveness of a special offering data 108 (e.g., the special offering data 108 of FIG. 1), according to one embodiment. In operation 802, a special offering data (e.g., the special offering data 108 of FIG. 1) of a mark-up language site (e.g., the mark-up language site of the merchant device 104) may be identified when an identification data of the mark-up language site is matched with a deal marker data (e.g., keywords, deal identification data, etc.). In operation 804, the special offering data may be compared with a parameter (e.g., the parameters 516 of FIG. 5) of a known offering data (e.g., associated to the inventory database 210) to determine a substantial match between the special offering data 108 and the known offering data. In operation 806, the special offering data 108 may be periodically indexed when the special offering data 108 has a distinctive competitive advantage (e.g., in terms of item price, item availability, item quality etc.) when compared with the known offering data. In operation 808, the deal marker data may be automatically populated (e.g., as described in FIG. 2) by evaluating a previously examined mark-up language site (e.g., a mark-up language file that was previously examined by the fetcher module 214 and did not return any matches for the deal marker data) through an algorithm that compares each offering (e.g., data associated to each item) on the mark-up language site with a market value (e.g., market price) of the each offering (e.g., by referencing the inventory database 210), such that the deal marker data is an identifier data (e.g., the identification data) associated with the special offering data 108 having a selling price lower than a threshold value from the known offering data (e.g., known inventory data). In operation 810, the deal index 208 may be formed through periodically indexing the special offering data 108 (e.g., the special offering data 108 of FIG. 1). In operation 812, an item query of the client device 106 (e.g., the client device 106 of FIG. 1) may be analyzed using the deal index 208 (as described in the query analysis module 204 of FIG. 2) to determine a special item (e.g., the special item 412 of FIG. 4) of the deal index 208 that substantially matches the item query.

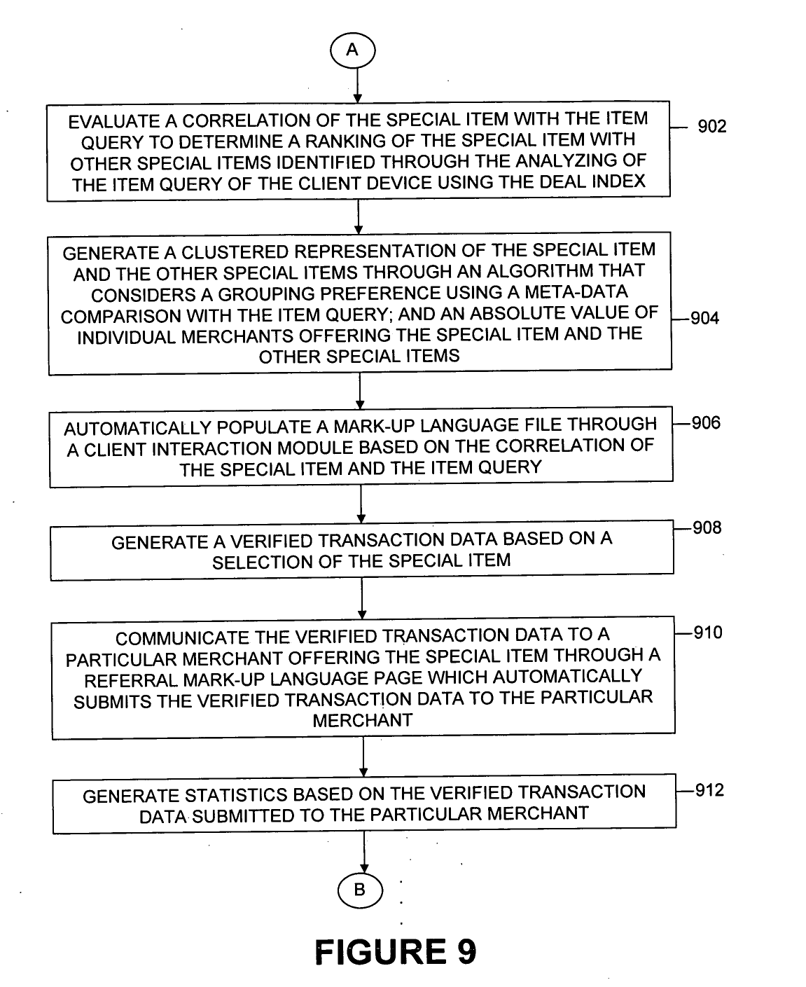

FIG. 9 is a process diagram that describes further the operations in FIG. 8, according to one embodiment. FIG. 9 begins with a ‘circle A’ that connotes a continuation from operation 812 of FIG. 8 (e.g., FIG. 8 concludes with the ‘circle A’). First in operation 902, a correlation of the special item with the item query may be evaluated to determine a ranking of the special item (e.g., the special item 412 of FIG. 4) with other special items (e.g., as described in the query analysis module 204 of FIG. 2) identified through the analyzing of the item query of the client device 106 using the deal index 208. In operation 904, a clustered representation (e.g., shown as a choice in FIG. 4) of the special item and the other special items may be generated through an algorithm (e.g., algorithms 242 of FIG. 2) that considers a grouping preference using a meta-data comparison with the item query and an absolute value of individual merchants (e.g., a count of merchants) offering the special item and the other special items.

In operation 906, a mark-up language file 240 (e.g., the mark-up language file 240 of FIG. 2) may be automatically populated through a client interaction module 232 (e.g., the client interaction module 232 of FIG. 2) based on the correlation of the special item and the item query. In operation 908, a verified transaction data may be generated (e.g., using the transaction module 206 of FIG. 2) based on a selection of the special item. In operation 910, the verified transaction data may be communicated to a particular merchant offering the special item (e.g., the special item 412 of FIG. 4) through a referral mark-up language page (e.g., referral web-page) which automatically submits the verified transaction data to the particular merchant. In operation 912, statistics (e.g., referral statistics) may be generated (e.g., by using the referral module 246 of FIG. 2) based on the verified transaction data submitted to the particular merchant.

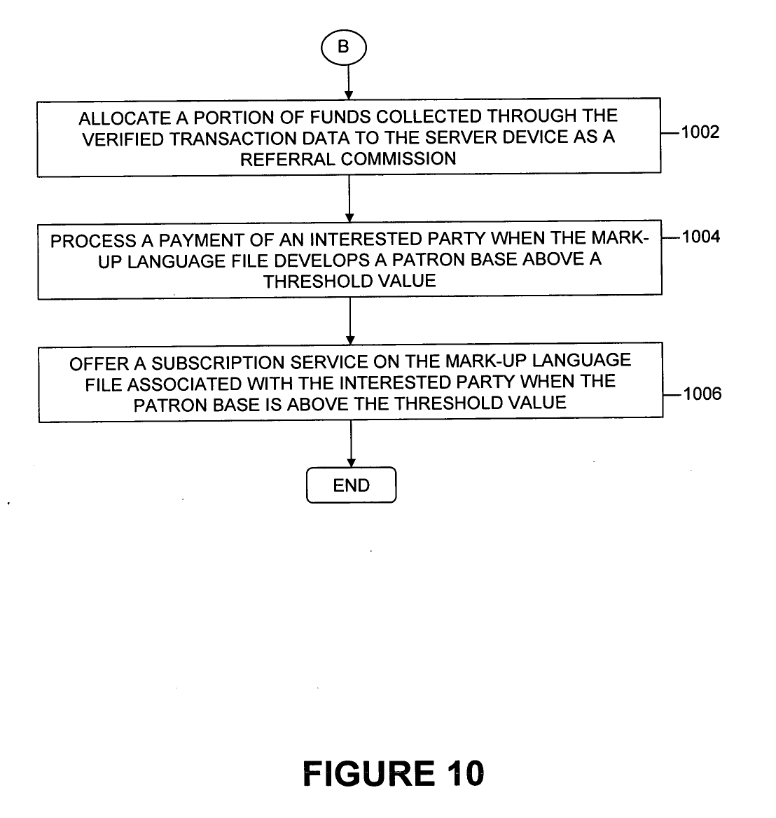

FIG. 10 is a process diagram that describes further the operations in FIG. 9, according to one embodiment. FIG. 10 begins with a ‘circle B’ that connotes a continuation from operation 912 of FIG. 9 (e.g., FIG. 9 concludes with the ‘circle B’). First in operation 1002, a portion of funds collected through the verified transaction data may be allocated to the server device 100 (e.g., the server device 100 of FIG. 1) as a referral commission. In operation 1004, a payment of an interested party (e.g., a merchant) may be processed when the mark-up language file (e.g., the mark-up language file 240 of FIG. 2) develops a patron base (e.g., a user base) above a threshold value (e.g., a set minimum) and a subscription service 308 (e.g., the subscription service 308 of FIG. 4) may be offered on the mark-up language file 240 associated with the interested party when the patron base is above the threshold value.

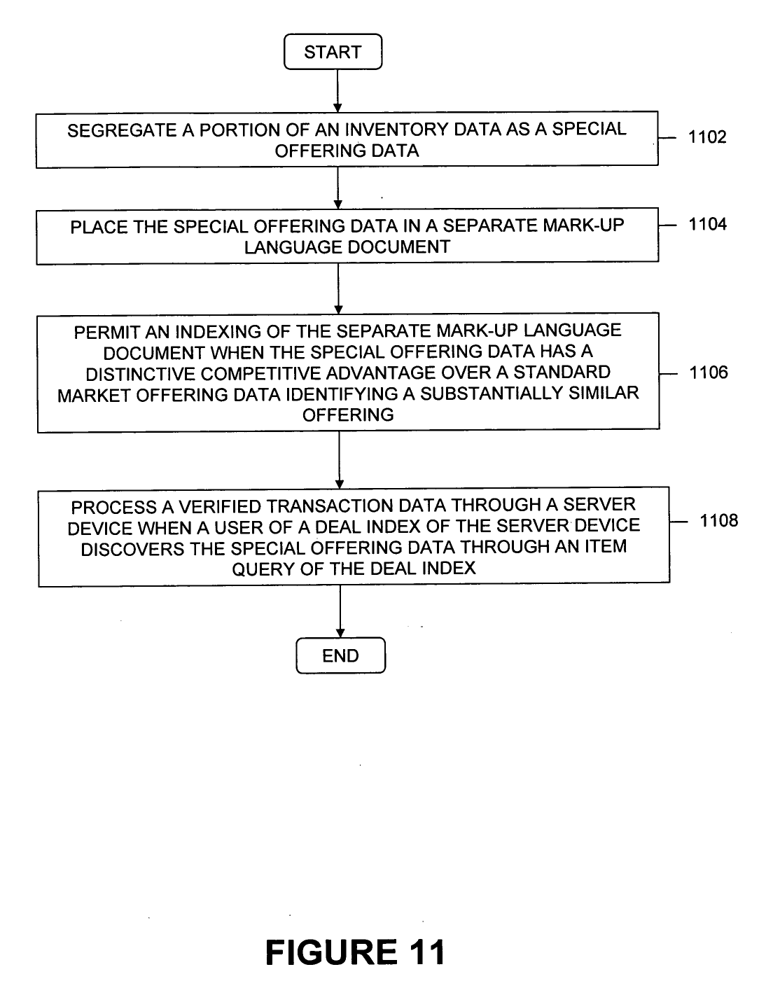

FIG. 11 is a flow chart illustrating a method of the merchant device 104 (e.g., the merchant device 104 of FIG. 1) to segregate and permit indexing of the special offering data 108 (e.g., the special offering data 108 of FIG. 1). In operation 1102, a portion of an inventory data (e.g., the inventory data of the merchant device 104) may be segregated as a special offering data 108. In operation 1104, the special offering data 108 may be placed in a separate mark-up language document. In operation 1106, an indexing of the separate mark-up language document may be permitted when the special offering data 108 has a distinctive competitive advantage (e.g., in terms of item price, item availability, item quality etc.) over a standard market offering data (e.g., a standard market item) identifying a substantial similar offering. In operation 1108, a verified transaction data (e.g., verified by the server device 100) may be processed through a server device 100 (e.g., the server device 100 of FIG. 1) when a user of a deal index 208 of the server device 100 discovers the special offering data 108 through an item query of the deal index 208.

Although the present embodiments has been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the deal analysis module 200 (and all the modules in the deal analysis module as illustrated in FIG. 2), the deal processing module 202 (and all the modules in the deal processing module 202 as illustrated in FIG. 2), the query analysis module 204 (and all the modules in the query analysis module 204 as illustrated in FIG. 2) and/or the transaction module 206 (and all the modules in the transaction module 206 of FIG. 2), may be enabled using transistors, logic gates, and electrical circuits (e.g., application specific integrated ASIC circuitry) using a deal analysis circuit, a deal processing circuit, a query circuit and/or a transaction circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a server device comprising:
identifying a special offering data of a mark-up language site when an identification data of the mark-up language site is matched with a deal marker data;
comparing the special offering data with a parameter of a known offering data to determine a substantial match between the special offering data and the known offering data; and
periodically indexing the special offering data when the special offering data has a distinctive competitive advantage when compared with the known offering data.

2. The method of claim 1 further comprising automatically populating the deal marker data by evaluating a previously examined mark-up language site through an algorithm that compares each offering on the mark-up language site with a market value of the each offering, such that the deal marker data is an identifier data associated with the special offering data having a selling price lower than a threshold value from the known offering data.

3. The method of claim 2 wherein the threshold value is less than 10% below the market value of the known offering data.

4. The method of claim 1 wherein the special offering data is a portion of the mark-up language site, and only the portion of the mark-up language site having the special offering data is periodically indexed.

5. The method of claim 1 further comprising:
forming a deal index through periodically indexing the special offering data;
analyzing an item query of a client device using the deal index to determine a special item of the deal index that substantially matches the item query; and
evaluating a correlation of the special item with the item query to determine a ranking of the special item with other special items identified through the analyzing of the item query of the client device using the deal index.

6. The method of claim 5 further comprising generating a clustered representation of the special item and other special items through an algorithm that considers a grouping preference using a meta-data comparison with the item query; and an absolute value of individual merchants offering the special item and other special items.

7. The method of claim 5 further comprising automatically populating a mark-up language file through a client interaction module based on the correlation of the special item and the item query.

8. The method of claim 5 further comprising:
generating a verified transaction data based on a selection of the special item; and
communicating the verified transaction data to a particular merchant offering the special item through a referral mark-up language page which automatically submits the verified transaction data to the particular merchant.

9. The method of claim 8 further comprising:
generating statistics based on the verified transaction data submitted to the particular merchant; and
allocating a portion of funds collected through the verified transaction data to the server device as a referral commission.

10. The method of claim 5 further comprising:
processing a payment of an interested party when the mark-up language file develops a patron base above a threshold value; and
offering a subscription service on the mark-up language file associated with the interested party when the patron base is above the threshold value.

11. The method of claim 10 wherein the subscription service is at least one of an advertisement space, a sponsored recommendation and a web feature.

12. The method of claim 1 wherein the distinctive competitive advantage is at least one of a lower selling price, a faster shipping time, a larger available stock, a geographic proximity, a credibility rating, and a quality metric when compared to an industry benchmark.

13. The method of claim 12 wherein the industry benchmark is periodically refreshed through an automatic comparison of the special offering data with the known offering data of a plurality of merchants.

14. The method of claim 1 wherein the parameter of the known offering data is at least one of an item identifier, an item description, an item brand and an item price.

15. The method of claim 1 in a form of a machine-readable medium embodying a set of instructions that, when executed by a machine, causes the machine to perform the method of claim 1.

16. A method of a merchant device, comprising:
segregating a portion of an inventory data as a special offering data;
placing the special offering data in a separate mark-up language document; and
permitting an indexing of the separate mark-up language document when the special offering data has a distinctive competitive advantage over a standard market offering data identifying a substantially similar offering.

17. The method of claim 16 further comprising processing a verified transaction data through a server device when a user of a deal index of the server device discovers the special offering data through an item query of the deal index.

18. The method of claim 16 wherein the distinctive competitive advantage is at least one of a lower selling price, a faster shipping time, a larger available stock, a geographic proximity, a credibility rating, and a quality metric when compared to an industry benchmark.

19. A system comprising:
a plurality of merchant devices to segment a special inventory data from other inventory data; and
a server device communicatively coupled to the plurality of merchant devices to index the special inventory data when a portion of the special inventory data has a market value that is less than a threshold percentage as compared to an offer price of the portion of the special inventory data.

20. The system of claim 19 wherein the server device automatically discovers segment of the special inventory data by examining a link identifier associated with a mark-up language document of each of the plurality of merchant devices against a deal identifier library of the server device.
